(19) United States
(12) Patent Application Publication
(10) Pub. No.: US 2024/0042667 A1
(43) Pub. Date: Feb. 8, 2024

(54) METHOD AND DEVICE FOR COAXIALLY EXTRUDING AN EXTRUDED PRODUCT

(71) Applicant: TECHNISCHE UNIVERSITÄT BERLIN, Berlin (DE)

(72) Inventors: Sören MÜLLER, Berlin (DE); René NITSCHKE, Berlin (DE); Felix GENSCH, Hohen Neuendorf (DE); Sven GALL, Berlin (DE)

(73) Assignee: TECHNISCHE UNIVERSITÄT BERLIN, Berlin (DE)

(21) Appl. No.: 18/266,349

(22) PCT Filed: Dec. 9, 2021
(86) PCT No.: PCT/EP2021/085044

§ 371 Date: Jun. 9, 2023

(30) Foreign Application Priority Data
Dec. 11, 2020 (EP) 20213457.3

(51) Int. Cl. B29C 48/21; B29C 48/48; B29C 48/49

(52) U.S. Cl. CPC B29C 48/21; B29C 48/48; B29C 48/49

(57) ABSTRACT

The invention relates to a method for coaxially extruding an extruded product. Hereby, an extruding device comprises the following: a receiver (7); a first receiver bore (5) which is formed in the receiver (7) and in which a first punch (10) is arranged; a second receiver bore (6) which is formed in the receiver (7) inside the first receiver bore (5) and coaxially therewith and in which a second punch (11) is arranged; and a mold (15) having a mold cavity (14) which is connected to the first and the second receiver bore (5, 6). In the method, the following is provided: arranging a first material billet (8) of a first material (2) in the first receiver bore (5); arranging a second material billet (9) of a second material (3) in the second receiver bore (6); and extruding an extruded product (1) in which the first and the second material (2, 3) are connected in a form-fitting and integrally bonded manner. The extrusion comprises: advancing the first punch (10) in the first receiver bore (5) in such a manner that the first material (2) is pressed into the mold cavity (14) of the mold (15) and thereby shaped; advancing the second punch (11) in the second receiver bore (6) in such a manner that the second material (3) is pressed into the mold cavity (14) of the mold (15) and thereby shaped, the second punch (11) being displaced coaxially with the first punch (10); and connecting the first and the second material in an integrally bonded and form-fitting manner to form an extruded product (1) in the mold (15) in such a manner that the first material (2) surrounds the second material (3) in the extruded product (1). The invention also relates to a device for coaxially extruding an extruded product.

The invention relates to a method and a device for coaxially extruding an extruded product.

### BACKGROUND

In the field of massive forming, extrusion is an energy-efficient way of producing near-net-shape semi-finished products as extruded products from starting material in just one forming step. Various materials can be processed. In addition to light metals such as aluminum, magnesium and titanium, ferrous metals, non-ferrous metals and precious metals as well as their alloys can also be shaped. The process temperatures can be as high as about 1300° C., but can also be below 0° C. The method makes it possible to maintain extremely tight shape tolerances and, moreover, to adapt the chemical and physical properties of the pressed products to the specific requirements of the end products via the microstructure. In addition to cast starting material, forged intermediate products and powder materials are also suitable starting materials.

The ever more extensive requirement profiles for structural and functional components in the automotive, transportation, energy, medical and aerospace sectors are increasingly being met with load-adapted concepts. In addition to cross-sectionally optimized geometries, this also increasingly includes hybrid concepts in which different materials or alloys are used locally in the component. Common to all these concepts is the need for an additional joining process to produce an integrally bonded, force- or form-fitting connection. This takes place either before or after near-net-shape forming.

In order to connect metals in an integrally bonded manner, the pure metal surfaces must be brought together within an atomic distance. To this end, both a sufficiently high pressure and a sufficiently high temperature must prevail to level the surface roughness and produce the necessary approach, as well as to enable the diffusion processes necessary for chemical bonding. Since metal surfaces are generally covered with impurities and oxides, the “clean” surfaces must first be exposed in order to be able to create a bond at the atomic level. For this to succeed, the contact surfaces of the two metal volumes must be enlarged to a sufficient degree. However, the cover layers must not increase in size, or only to a very small extent in relation to the contact surface.

One possibility of rupturing the surfaces of joining partners is to shear them with respect to one another under the influence of normal stresses. In doing so, the surface is kneaded and thus enlarged, which causes the impurities and oxides to tear open so that the pure metal surface is exposed. Depending on the magnitude of shear introduced, the impurities and oxides can be finely crushed on the one hand and the surface significantly enlarged on the other.

Extrusion basically offers the possibility of “pressing” separate material streams together during the shaping process and thus creating a join in the extruded product, the so-called extruded seam or pressed seam. The temperatures and pressures required for this, as well as sufficient shear, can be introduced by means of the extrusion process. In this manner, different materials and alloys can be joined during extrusion. Various papers have investigated the extrusion of composites made of different metallic materials, and the influence of the process variables on the composite properties has been presented. Studies on the extrusion of material composites have also been carried out in the past at the Forschungszentrum Strangpressen (see Negendank et al, J. Mater Process Tech 212, 2012, 1954; Negendank et al, Key Engineering Materials 554-557, 2013, 767; Nitschke et al, Magnesium—10th International Conference on Magnesium alloys and their applications (Editor: K. U. Kainer), 2015, 478). It could be shown that material composites can be produced using different method variants of extrusion.

Material composites can be produced by means of the hydrostatic extrusion process with the application of an active medium (cf. Ruppin et al., Aluminium 56, 1980, 523). This makes it possible to prevent or reduce direct contact and thus solid-state friction between the billet, the receiver and the punch (cf. Bauser et al., Strangpressen, Aluminium-Verlag, Dusseldorf, 2001). For this reason, the method exhibits an almost ideal material flow and, for example, enables the production of Cu/Al composites or Cu/Nb3Sn superconductors, for example. However, the process-related effort required for billet preparation (geometric adaptation of the front of the billet to seal the receiver contents in the direction of the die) and the test execution (filling the receiver with the hydrostatic medium, sealing and removing after the extrusion process) are very labor-, time- and cost-intensive.

Cylindrical multi-material billets can be used in composite extrusion. For example, magnesium hybrids can be formed and joined by extrusion. However, the extrusion of alloy pairings with significant differences in forming resistances leads to considerable difficulties in establishing a homogeneous material flow, resulting in pronounced distortion in the profile and even degradation of the profile in the region of the extrusion seam. Furthermore, strong twistings and displacements of the boundary layer relative to the profile cross-section can occur. These effects can depend on the respective volume fractions and the position of the billet parts (cf. Nitschke et al., Magnesium—10th International Conference on Magnesium alloys and their applications (Editor: Kainer), 2015, 478).

In conjunction with coaxial extrusion of aluminum-magnesium composites, it has been shown that composites of magnesium and aluminum can be formed and joined by means of extrusion (see Negendank et al., J. Mater Process Tech 212, 2012, 1954; Negendank et al., Key Engineering Materials 554-557, 2013, 767).

### SUMMARY

It is the object of the invention to provide a method and a device for coaxially extruding an extruded product, with which extruded products can be produced in a more efficient and variable manner.

To achieve this object, a method and a device for coaxially extruding an extruded product according to independent claims 1 and 13 are created. Configurations are the subject matter of dependent subclaims.

According to one aspect, a method for producing an extruded product (extrusion molded product) is created. Hereby, an extruding device is provided, comprising: a receiver; a first receiver bore which is formed in the receiver and in which a first punch is arranged; a second receiver bore which is formed inside in the receiver and coaxially therewith and in which a second punch is arranged; and a mold having a mold cavity which is connected to the first and the second receiver bore. The method further provides: arranging a first material billet of a first material in the first receiver bore; arranging a second material billet of a second material in the second receiver bore; and extruding an extruded product in which the first and the second material are connected in a form-fitting and integrally bonded manner. Here, the extrusion further comprises: advancing (feeding) the first punch in the first receiver bore in such a manner that the first material is pressed into the mold cavity of the mold and thereby shaped; advancing (feeding) the second punch in the second receiver bore in such a manner that the second material is pressed into the mold cavity of the mold and thereby shaped; and connecting the first and the second material in an integrally bonded and form-fitting manner to form an extruded product in the mold.

According to another aspect, a device for coaxially extruding an extruded product is created, comprising: a receiver; a first receiver bore which is formed in the receiver and in which a first punch is arranged; a second receiver bore which is formed in the receiver inside the first receiver bore and coaxially therewith and in which a second punch is arranged; and a mold having a mold cavity which is connected to the first and the second receiver bore in such a manner that during extrusion by means of advancing the first punch in the first receiver bore and advancing the second punch coaxially with the first punch in the second receiver bore, a first material of a first material billet from the first receiver bore and a second material of a second material billet from the second receiver bore can be introduced into the mold cavity for producing an extruded product in which the first and the second material are connected in a form-fitting and integrally bonded manner.

The provision of at least two punches, which are arranged in separate receiving bores, makes it possible to operate the punches independently of one another during extrusion in order to introduce the respective material into the mold by means of advancing.

The movement of the punches during the advance is carried out coaxially in the associated receiver bores. The receiver bores can be coupled directly at the end to the mold cavity of the mold, so that the material passes from an outlet of the receiver bore directly into an inlet of the mold cavity. The receiver bores each form a press channel along which the material is subjected to a pressing pressure in order to introduce the material from the receiver bore into the mold and thereby shape it.

The receiver bores can be formed with a cylindrical shape.

During extrusion, the materials are connected in the mold along a join (joining seam) in an integrally bonded and form-fitting manner.

The materials can be metallic materials of different types, for example aluminum or magnesium.

The formation of separate receiver bores with respective punches enables advance movements of the punches in the receiver bores, which movements are decoupled from one another.

The integrally bonded and form-fitting connection can be carried out in the mold between the first and the second materials. The shear stress between the first and the second material in the mold cavity can be adjusted and varied by means of the decoupled advance movements of the punches in the separate receiver bores.

The first and the second material can be introduced into the mold cavity at different relative speeds. The adjustability of different relative speeds allows the extrusion process to be adapted to different materials. It also allows the production process to be optimized to meet the requirements for different extruded products.

A first advance when advancing the first punch in the first receiver bore and a second advance when advancing the second punch in the second receiver bore can be controlled independently of each other. The decoupled adjustability or controllability of the advance of the extrusion punches in the separate receiver bores enables individual adaptation or steering of the extrusion process to different process flows, for example depending on the materials and/or the extruded product to be produced.

Advancing the first punch in the first receiver bore can be carried out at a first advance speed, and advancing the second punch in the second receiver bore can be carried out at a second advance speed different from the first advance speed. In particular, by means of different advance speeds, the relative speeds for the materials during the transition from the receiver bore into the mold cavity of the mold can be adjusted.

The first punch, when moving in the first receiver bore, can be driven by means of a first actuator, and the second punch, when moving in the second receiver bore, can be driven by means of a second actuator which is formed separately from the first actuator and can be controlled. Alternatively, it can be provided to actuate the punches by means of an actuator that is jointly associated with the punches. The joint actuator can have decoupled actuator elements which can effect a decoupled advance movement of the punches.

A material that is different from the first material can be used as the second material. For example, different metallic materials can be used.

The same material can be used for the first and the second material.

An extruded profile can be produced as the extruded product. The extruded profile can be produced with any profile cross-sections. By means of the method, extruded profiles with axially variable volume fractions of different materials can be produced. Moreover, by using suitable die designs, extruded products with axially variable cross-sections and, at the same time, axially variable volume fractions of different materials can be produced.

An extruding device can be provided in which the second receiver bore is arranged in an inner cavity of the first punch. In this or other embodiments, the receiver bores can be formed with round, angular or oval cross-sections, in particular circular or different from circular.

An extruding device can be provided in which the second receiver bore is formed by the inner cavity of the first punch, and the second punch is received in the inner cavity in a form-fitting manner.

An extruding device can be provided in which the second receiver bore is formed by means of a sleeve component disposed in the inner cavity of the first extrusion punch, and the second punch is positively received in the inner cavity of the sleeve component.

An extruding device can be provided in which the first receiver bore and the second receiver bore are sealed from one another. In this case, the receiver bores can be sealed off from one another in a fluid-tight manner, in particular in a liquid-tight manner.

The receiver bores form a respective receptacle for the punch (punch receptacle).

The configurations explained above in connection with the method for coaxially extruding an extruded product can be provided accordingly in connection with the device for coaxial extrusion.

By means of the proposed technique, in one configuration, it can be provided that the individual material streams feed the mold cavity homogeneously so that as little shear as possible is generated in the direction of pressing within the mold cavity and in the region of the press channel. In this manner, the contact shear stresses and also the axial expansion differences between the material partners during the joining process can be minimized. A homogeneous strand exit velocity is achieved over the entire cross-section and damaging shear in the region of the boundary layer is prevented. In other words, this means that material streams with the same flow velocity are brought together in the mold cavity and can be pressed together by a minimum pressure to produce an integrally bonded hybrid (extruded product).

Thus, in one embodiment, material streams of the same speed can be implemented locally with different extrusion materials which have different forming resistances and process windows. This cannot be implemented when using a classic extrusion press with only one punch. In particular, when using the classic extrusion press with only one punch, it is not possible to set the pressure in the primary forming zone, welding chamber and press channel at the same level to prevent the boundary layer shift.

It can be provided to locally adapt the cross-section of extruded composite profiles during the production of the extruded product in accordance with the loads on parts and components prevailing in use. For example, it can be provided to make the wall thickness of a material responsible for load absorption in the extruded product thicker in first regions than in regions subjected to lower loads (second regions different from the first regions), which are then made with a smaller wall thickness. The development of load-adapted, customized profiles can reduce the weight of extruded components or parts compared to those produced via the conventional production process.

### DESCRIPTION OF EXEMPLARY EMBODIMENTS

In the following, further exemplary embodiments are explained with reference to figures of a drawing. In the figures:

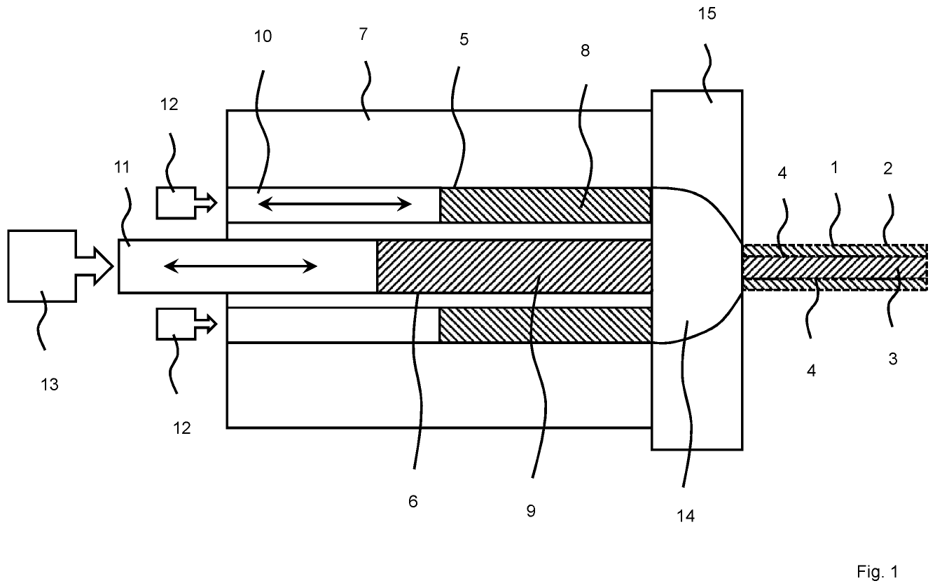

FIG. 1 shows a schematic illustration of a device for producing an extruded product;

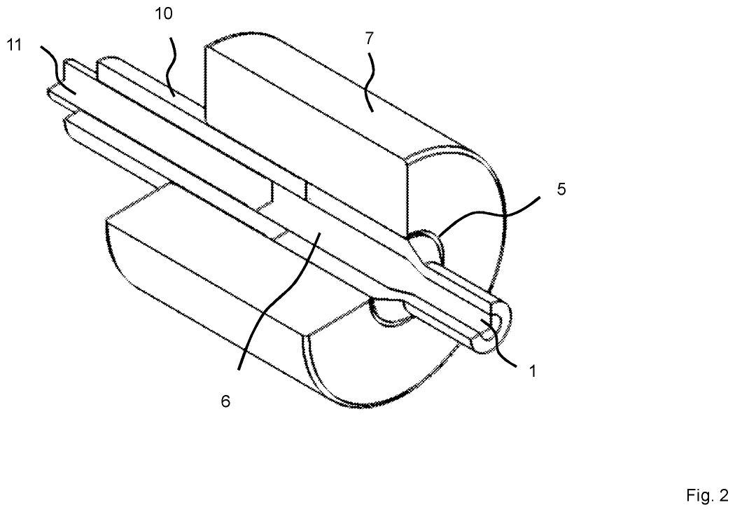

FIG. 2 shows a perspective illustration of a receiver for an extruding device in elevation, in which a first and a second punch are arranged in a coaxial arrangement corresponding to a first and a second receiver bore;

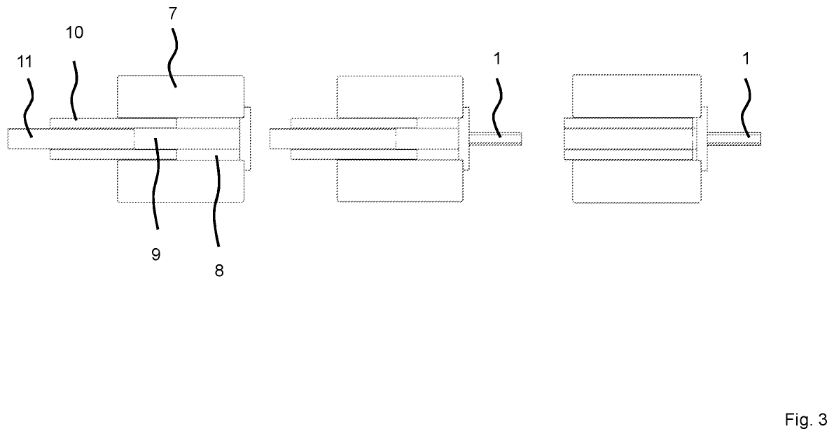

FIG. 3 shows a schematic illustration of a cross-section of an arrangement with two punches for pressing material billets of different lengths; and

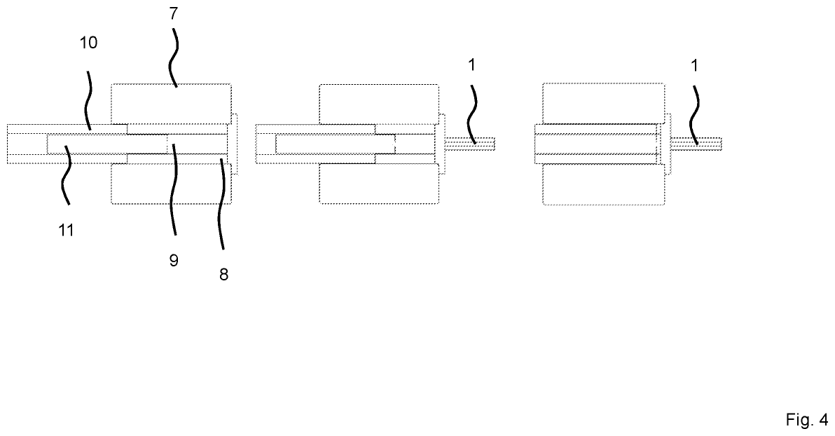

FIG. 4 shows a schematic illustration of a cross-section of a further arrangement with two punches for pressing material billets of different lengths.

FIG. 1 shows a schematic illustration of a cross-section of a device for producing an extruded product 1 by means of coaxial extrusion. In the extruded product 1, a first material 2 and a second material 3 are joined together along a circumferential join or joining seam 4 in a form-fitting and integrally bonded manner by means of extrusion in such a manner that the second material 3 is surrounded axially circumferentially by the first material 2. The extruded product 1 can be an extruded profile.

The formulations “extruded profile” and “extruded product” in the meanings used herein comprise all profile geometries that can be produced by means of the extrusion process. This includes, for example, solid profiles as well as hollow profiles and semi hollow profiles in any geometries. For example, extruded “sheets” as well as tubes, window profiles or round bars are known as extruded profiles.

For producing the extruded product 1, a first material billet 8 made of the first material 2 and a second material billet 9 made of the second material 3 are arranged in a first and a second receiver bore 5, 6 of a receiver 7. The first and the second receiver bore 5, 6 provide a respective channel with a cylindrical shape, which can have a round, angular or oval cross-section. A first and a second punch 10, 11 are arranged in the receiver bores 5, 6, each of which can be displaced in the axial direction and in this respect coaxially with respect to one another in the associated receiver bore 5, 6.

The first punch 10 is designed as a hollow component and surrounds the second receiver bore 6 when it is inserted into the first receiver bore. A wall 6a which delimits the second receiver bore 6 and the inner side of which faces the second receiver bore 6 can be designed as a separate wall between the first and the second receiver bore 5, 6. Alternatively, the second receiver bore 6 can be formed by means of a cavity in the first punch 10. In this case, the second punch 11 can slide or slip within the cavity of the first punch 10 during the advance.

A first and a second actuator 12, 13 are associated with the first and the second punch 10, 11, which actuators are configured to apply force to the respective punch 10, 11 so that the punches 10, 11 perform a coaxial advance movement in the direction of a mold cavity 14 of a mold 15 in order to introduce the first and the second material 2, 3 into the mold cavity 14. For this purpose, the first and the second receiver bore 5, 6 are in communication with the mold cavity 14 in such a manner that the material of the first and the second material billet 8, 9 is introduced into the mold cavity 14 and is shaped in the process. The pressurization results in the fact that the join 4 between the first and second materials 2, 3 is formed in the mold cavity 14.

According to the schematic illustration in FIG. 1, the first actuator 12 is shown in two parts or pieces. However, it can be a single first actuator.

By means of the first and the second actuator 12, 13, the first and the second punch 10, 11 can perform advance movements decoupled from each other during extrusion. In particular, the first and the second punch 10, 11 can move at different speeds during advance. By means of the independent setting of the two advance movements, it is possible to set different flow velocities for the transition of the first and the second material 2, 3 into the mold cavity 14. The first and the second material 2, 3, which form an outer and an inner material, can be, for example, different metallic materials, but the use of the same metallic materials for the two material billet 8, 9 can also be provided. The extruded product 1 produced can be an extruded profile.

Further exemplary embodiments are explained below with reference to FIGS. 2 to 4. For identical features, the same reference signs as in FIG. 1 are used.

FIG. 2 shows a schematic illustration of an arrangement for an extruding device for coaxial extrusion, in which the first and the second punch 10, 11 are arranged in the first and the second receiver bore 5, 6. While the first punch 10 is designed as a hollow punch, the second punch 11 is a solid punch. In the first punch 10, the second receiver bore 6 for the second punch 11 is formed such that an outer surface of the second punch 11 and an inner surface of the first punch 10 are arranged opposite each other and in contact with each other

A form-fitting seal can be achieved by means of a so-called “press plate” (not shown) positioned between the punch 10, 11 and the material billets 8, 9. This press plate is used both fixed—in the sense of “temporarily structurally connected to each other, but interchangeable”—and loose.

FIG. 3 shows a schematic illustration of elements of an arrangement for an extruding device for coaxial extrusion, in which the first and second material billet 8, 9 are formed with different billet lengths. In the embodiment shown in FIG. 3, the first material billet 8 is shorter than the second material billet 9. In another embodiment shown in FIG. 4, the length ratio of the first and second material billet 8, 9 is reversed. The illustrations in FIGS. 3 and 4 then show, from left to right, the increasing advance of the first and the second punch 11 to produce the extruded product 1.

In the following, aspects relating to further embodiments are explained.

The method for hybrid extrusion by means of the multi-punch system uses, for example, the dual-punch design explained above with the multi-hole recipient or receiver 7 having the at least two bores for the receiver bores 5, 6 in a coaxial arrangement and the corresponding number of individually movable and controllable punches 10, 11. The mold 15 (extrusion die) is fed by the separate material streams. The mold cavity 14 provides a welding chamber to join the partial strands of the materials by the action of pressure and temperature.

The punches 10, 11 move the pressed material in the material billets 8, 9 either at the same speed or at different speeds in the direction of the mold 15, depending on the individual volume flows. The individual receiver bores 5, 6 and corresponding press plates do not have to have the same diameters.

In the method, the material billets 8, 9 are moved through the receiver bores 5, 6 in the direction of the mold 15 (die) in a manner comparable with direct extrusion. In doing so, due to the relative movement between the inner walls of the receiver bores 5, 6 and the outer surfaces of the material billets 8, 9, large parts of the oxides and impurities of the extrusion billets can already be retained. The material streams feeding the mold cavity 14 are already sheared and contain only a small amount of impurities. Material streams with virtually clean metallic surfaces enter the mold cavity 14. These are joined in mold cavity 14 and exit the mold 15 through the press channel as a composite strand (extruded product 1).

Depending on the individual extrusion ratios provided for the individual material streams, the punch speeds can be adapted so that, in accordance with the product specification, defined volume fractions of the individual composite partners in the product can be implemented. At the same time, a defined positioning of the boundary layer is achieved by specifying the volume fractions.

In the case of pressing at the same speed of both punches 10, 11 and a constant billet length, a profile is pressed in which the composite materials are pressed out symmetrically next to each other in the same ratio. By means of a selectively adjustable temperature difference between the two material billets 5, 6, composite flat profiles can be produced from separate containers both from material pairs with small and with large differences in forming resistance.

In the case that both materials 2, 3 are to be present in different volume fractions in the extruded product 1, this results in different extrusion ratios for each material (hybrid partner) if the container geometry is maintained. This is taken into account by steering the billet length in conjunction with two punches moving at different speeds. For this purpose, it is necessary for both punches 10, 11 to be displacement-controlled. In order to be able to control the punches 10, 11 autonomously, the extrusion press can have a separate hydraulic system for the movement of the punches 10, 11.

In the embodiments described, one or more of the following advantages over known extrusion methods can be achieved: Thermal and tribological decoupling of the material partners; adjustability of different billet temperatures; separate control of the flow rates of the material partners; individual adaptation of the required process variables; and targeted steering of the material flows for variable volume ratios (load/function-adapted cross-sections).

The method enables the production of metallic material composites within a single massive forming step. By using separately controllable punches and the possibility of implementing different receiver bores (punch receptacles), the flow of the material partners with significantly different flow stresses can be set in such a manner that a defined material arrangement (volume ratio of the material partners or wall thickness of the material partners, formation of the boundary layer) can be set over the complete profile length of the extruded product 1.

The features disclosed in the above description, the claims and the drawing can be of importance both individually and in any combination for the implementation of the various embodiments.

1. A method for coaxially extruding an extruded product, comprising
providing an extruding device comprising
a receiver;
a first receiver bore which is formed in the receiver and in which a first punch is arranged; and
a second receiver bore which is formed in the receiver inside the first receiver bore and coaxially therewith and in which a second punch is arranged; and
a mold having a mold cavity which is connected to the first and the second receiver bore;
arranging a first material billet of a first material in the first receiver bore;
arranging a second material billet of a second material in the second receiver bore; and
extruding an extruded product in which the first and the second material are connected in a form-fitting and integrally bonded manner, comprising:
advancing the first punch in the first receiver bore in such a manner that the first material is pressed into the mold cavity of the mold and is thereby shaped;
advancing the second punch in the second receiver bore in such a manner that the second material is pressed into the mold cavity of the mold and thereby shaped, the second punch thereby being displaced coaxially with respect to the first punch; and
connecting the first and the second material in an integrally bonded and form-fitting manner to form an extruded product in the mold in such a manner that the first material surrounds the second material in the extruded product.

2. The method according to claim 1, characterized in that the connecting in a integrally bonded and form-fitting manner in the mold is carried out between the first and the second material.

3. The method according to claim 1, characterized in that the first and the second material are introduced into the mold cavity at different relative speeds.

4. The method according to claim 1, characterized in that a first advance when advancing the first punch in the first receiver bore and a second advance when advancing the second punch in the second receiver bore are set independently of one another.

5. The method according to claim 1, characterized in that the advancing of the first punch in the first receiver bore is carried out at a first advance speed and the advancing of the second punch in the second receiver bore is carried out at a second advance speed which is different from the first advance speed.

6. The method according to claim 1, characterized in that the first punch, when moving in the first receiver bore, is driven by means of a first actuator and the second punch, when moving in the second receiver bore, is driven by means of a second actuator which is formed separately from the first actuator and is controllable.

7. The method according to claim 1, characterized in that a material which is different from the first material is used as the second material.

8. The method according to claim 1, characterized in that the same material is used for the first and the second material.

9. The method according to claim 1, characterized in that an extruded profile is produced as the extruded product.

10. The method according to claim 1, characterized in that an extruding device is provided in which the second receiver bore is arranged in an inner cavity of the first punch.

11. The method according to claim 10, characterized in that an extruding device is provided in which the second receiver bore is formed by the inner cavity of the first punch and the second punch is received in the inner cavity in a form-fitting manner.

12. The method according to claim 10, characterized in that an extruding device is provided in which the second receiver bore formed by means of a sleeve component which is arranged in the inner cavity of the first punch, and the second punch is received in the inner cavity of the sleeve component in a form-fitting manner.

13. A device for coaxially extruding an extruded product, comprising
a receiver;
a first receiver bore which is formed in the receiver and in which a first punch is arranged;
a second receiver bore which is formed in the receiver inside the first receiver bore and coaxially therewith and in which a second punch is arranged; and
a mold having a mold cavity which is connected to the first and the second receiver bore in such a manner that during extrusion by means of advancing the first punch in the first receiver bore and advancing the second punch coaxially with the first punch in the second receiver bore, a first material of a first material billet from the first receiver bore and a second material of a second material billet from the second receiver bore can be introduced into the mold cavity for producing an extruded product in which the first and the second material are connected in a form-fitting and integrally bonded manner.
